(19) United States
(12) Patent Application Publication
(10) Pub. No.: US 2008/0284909 A1
(43) Pub. Date: Nov. 20, 2008

(54) Remote Multimedia Monitoring with Embedded Metrics

(76) Inventors: Michael F. Keohane, Shrewsbury, MA (US); James A. Clark, Cumming, GA (US); Adrian C. Smethurst, Groton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/749,514

(22) Filed: May 16, 2007

(51) Int. Cl. H04L 12/56

(52) U.S. Cl. 348/468

(57) ABSTRACT

In one embodiment, a method includes receiving a copy of a multimedia flow from a point along the path of the multimedia flow through a communication network of nodes, receiving metric information associated with the multimedia flow from one or more probes coupled to the flow path and combining the copy of the multimedia flow and at least a portion of the metric information to provide a combined signal.

### TECHNICAL FIELD

The present disclosure relates generally to monitoring of multimedia signals.

### BACKGROUND

Telecommunications have converged to the point where voice, data, video and internet services are increasingly being carried over the same network using common protocols such as Transmission Control Protocol/Internet Protocol (TCP/IP) and other standard communications protocols. Because of the expansive growth of these services, service providers are looking for ways to monitor and troubleshoot these networks more intelligently. The ability to remotely analyze the quality of video services is of particular importance to the service providers.

### BRIEF DESCRIPTION OF THE DRAWINGS

Illustrated in the accompanying drawings are example embodiments in which like reference characters refer to the same parts throughout the different views. The drawings are not necessarily to scale, emphasis instead being placed upon illustrating example embodiments.

FIG. 1 illustrates an example communications network with remote monitoring of a multimedia flow.

FIG. 2 illustrates an example management unit.

FIG. 3 illustrates a process for monitoring metrics information associated with a selected multimedia flow.

FIG. 4 illustrates a process for selecting and receiving a copy of a multimedia flow.

FIG. 5 illustrates a process for combining metrics information with a selected multimedia flow.

### DESCRIPTION OF EXAMPLE EMBODIMENTS

Overview

A method comprises receiving a copy of a multimedia flow from a point along the path of the multimedia flow through a communication network of nodes and receiving metric information associated with the multimedia flow from one or more probes coupled to the flow path. The copy of the multimedia flow and at least a portion of the metric information are combined to provide a combined signal for display.

An entity in a communication network of nodes includes a network interface configured to receive a copy of a multimedia flow from a point along the path of a multimedia flow through the network of nodes and to receive metric information associated with the multimedia flow from one or more probes coupled to the flow path. The entity further includes processing circuitry configured to combine the copy of the multimedia flow and at least a portion of the metric information to provide a combined signal for display.

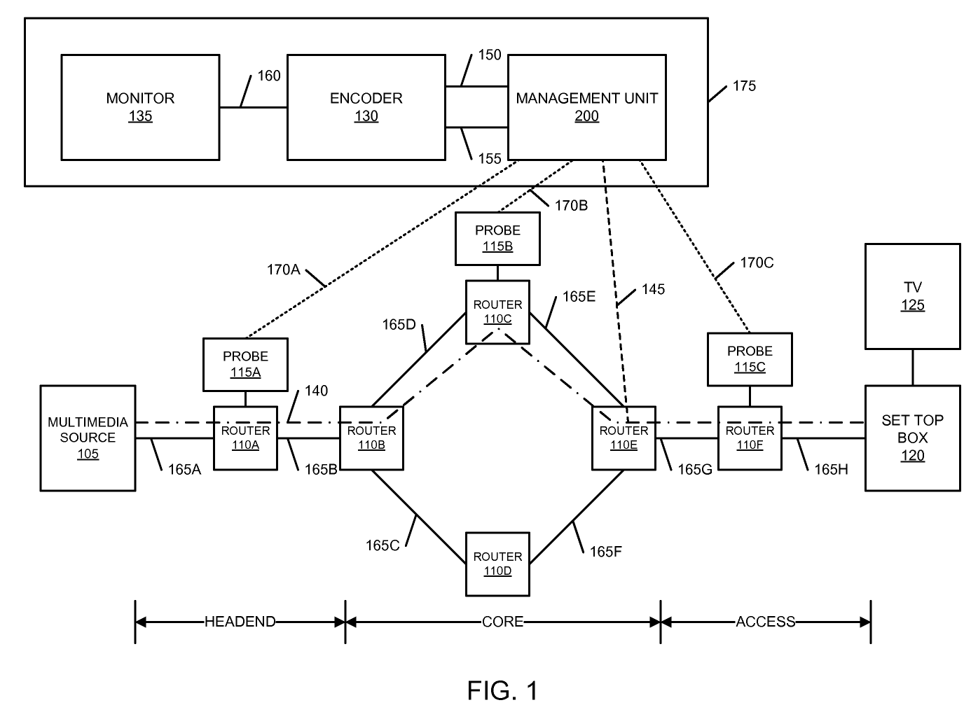

FIG. 1 illustrates an example communications network with remote monitoring of a multimedia flow. The network comprises a collection of communication links 165 interconnecting a plurality of nodes including routers 110 to form an internetwork of nodes. The nodes communicate by exchanging packets according to a pre-defined set of network protocols, such as TCP/IP. A protocol, as used herein, is a set of formal rules describing, e.g., how to transfer information between two entities in a communication network.

The routers 110 are conventional routers configured to form a conventional wide-area network (WAN). A multimedia source 105 is connected to the network through router 110A and provides a multimedia flow 140 across the network to a set top box 120. The multimedia source 105 is a conventional source of digital media content, such as a cable television headend, a video server and the like configured to provide a multimedia stream such as a movie, video, audio program and the like. The set top box 120 is a conventional set top box configured to process multimedia flows transmitted by the multimedia source 105 to provide audio, video and data output signals to a television 125. In other embodiments, the multimedia flow may terminate directly at a cable-ready television or at a personal computer for processing and viewing rather than the set top box 120 and television 125.

Probes 115 may be deployed strategically at headend, core and access portions of the network to collect metrics. The probes 115 may be connected to the routers 110 in a specific manner that allows traffic to be examined out-of-band so as not to adversely affect quality of the multimedia flow. The probes 115 may be conventional external probes such as those provided by IneoQuest Technologies, Inc. or may be probes that are integrated into the router. Of interest are metrics such as diagnostics, network configuration information (e.g., routes, mcast tree) and audio, video and data measurements. A particular metric of interest is the media delivery index (MDI) as defined in “A Proposed Media Delivery Index (MDI),” RFC 4445, April 2006. MDI is a measurement that can be used as a diagnostic tool or a quality indicator for monitoring a network intended to deliver applications such as streaming media, MPEG video, Voice over IP, or other information sensitive to arrival time and packet loss. It provides an indication of traffic jitter, a measure of deviation from nominal flow rates, and a data loss at-a-glance measure for a particular flow. For instance, the MDI may be used as a reference in characterizing and comparing networks carrying user datagram protocol (UDP) streaming media. The MDI provides an indication of expected video quality based on network level measurements. It is independent of the video encoding scheme and is a lightweight, scalable alternative to measurements that decode and examine the video itself. The MDI is typically displayed as two numbers separated by a colon: the delay factor (DF) and the media loss rate (MLR).

A remote management station 175 connected to the network includes a management unit 200, encoder 130 and a monitor 135. For example, the remote management station 175 may be located at a network operations center (NOC) of a service provider. The management unit 200, described further herein, is configured for remote monitoring of multimedia flows. The flows may be pulled periodically or in response to a trouble report. With the present approach, a NOC operator may receive a visual confirmation and embedded real-time or near real-time measurements on the state of the particular flow of interest. In addition, the flow may be pulled from different segments along the flow path through the network for comparison and problem isolation.

In operation, the management unit 200 opens a connection 145 to one of the routers 110 along the path of the multimedia flow 140 and pulls a copy of the multimedia flow into the connection. The management unit 200 also receives metric information 170 (such as MDI) associated with the multimedia flow 140 from one or more of the probes 115 coupled to the flow. At encoder 130 a signal 150 representative of the copy of the multimedia flow is combined with at least a portion 155 of the metric information to provide a combined signal 160 that may be sent to a monitor 135 for display. The encoder 130 may be a conventional encoder that is capable of encoding the metric information to various types of signals for embedding with the multimedia flow, e.g., closed caption signal, text-to-audio stream, second audio program, scrolling message signal as an element in an elementary program stream or an overlay graphic to a program stream, picture-in-picture signal and the like. The monitor 135 may be local to the management unit 200 or remote. In other embodiments, the combined stream may be re-transmitted via unicast or multicast for remote diagnostic viewing.

By combining the metric information with a copy of the multimedia flow for diagnostic viewing at a common display, both quantitative and qualitative assessments of the network performance may be made in one location and simultaneously.

It should be noted that the communication network illustrated herein is one example of a network that may be used with the techniques described herein. Other networks, including networks that are more complex than the illustrated network, may be adapted to implement the techniques described herein.

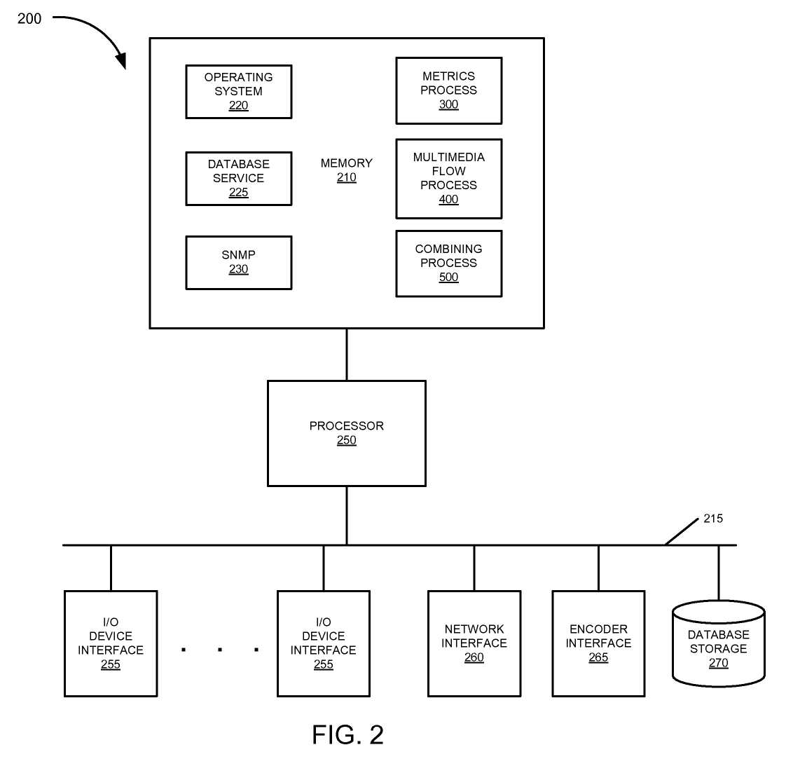

FIG. 2 is an illustration of an example management unit 200 that may be used with the techniques described herein. The management unit 200 comprises a memory 210 coupled to a processor 250 which is coupled to various interfaces via an input/output (I/O) bus 215. These interfaces may include I/O device interfaces 255, network interface 260, encoder interface 265 and database storage 270. The processor 250 is a conventional central processing unit (CPU) comprising processing circuitry that is configured to, inter alia, execute various instructions and manipulate data structures contained in memory 210.

The I/O device interfaces 255 comprise logic that interfaces various input and/or output devices, such as a keypad or mouse, with the processor 250 and enable signals and information to be transferred between the devices and the processor 250.

Network interface 260 is a conventional network interface comprising circuitry configured to enable data to be transferred between the management unit 200 and the network. To that end, network interface 260 incorporates signal, electrical and mechanical characteristics, and interchange circuits, needed to interface with the physical media of the network and protocols running over that media.

Encoder interface 265 comprises circuitry configured to enable data signals to be coupled between the management unit 200 and the encoder 130.

The memory 210 is a computer-readable medium organized as a random access memory (RAM) that is illustratively implemented using RAM devices. These devices may comprise some combination of non-volatile memory devices, such as flash memory devices, and volatile devices, such as Dynamic RAM (DRAM) devices. The memory 210 is configured to hold various computer-executable instructions and data structures including computer-executable instructions and data structures that implement aspects of the techniques described herein.

The memory comprises an operating system (O/S) 220, database service 225, SNMP process 230, metrics process 300, multimedia flow process 400 and combining process 500. The operating system 220 is illustratively a conventional operating system that is configured to implement various conventional operating system functions, such as task and process scheduling, as well as memory management and controlled access to various devices, such as I/O device interfaces 255 and database storage 270. The processes 225, 230, 300, 400 and 500 may comprise computer-executable instructions and data that are configured to implement various aspects of the techniques described herein.

By operation of metrics process 300 and multimedia process 400, described further herein, information (e.g., data packets containing metric information 170, multimedia flow packets received over connection 145) is received from the network by management unit 200 at its network interface 260 and may be transferred to the processor 250 for further processing. This processing may include storing certain information about the received metrics and multimedia flow to database storage 270 using conventional database service 225. Received data packets may be forwarded from the management unit 200 at its encoder interface 265 to the encoder 130 by operation of combining process 500 described further herein.

It should be noted that functions performed by the management unit 200, including functions that implement aspects of the techniques described herein, may be implemented in whole or in part using some combination of hardware and/or software. It should be further noted that computer-executable instructions and/or data that implement aspects of the techniques described herein may be stored in various computer-readable mediums, such as flash memories, removable disks, non-removable disks and the like. In addition, it should be noted that various electromagnetic signals such as wireless signals, electrical signals carried over a wire, optical signals carried over optical fiber and so on may be encoded to carry computer-executable instructions and/or data that implement aspects of the present invention on, e.g., a communication network.

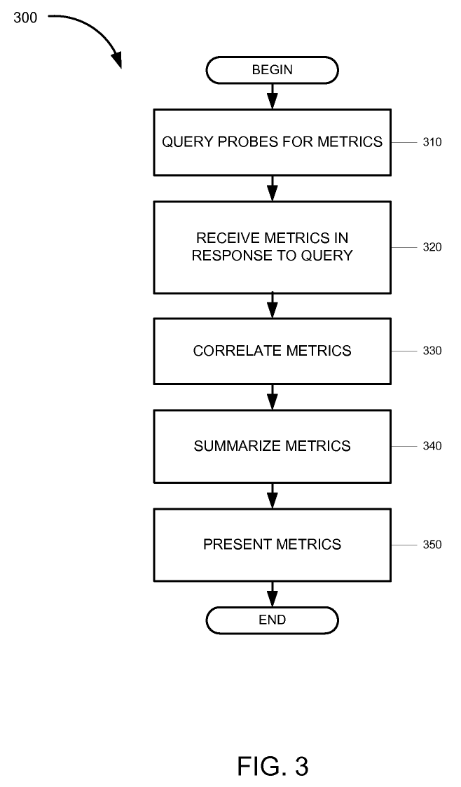

FIG. 3 illustrates a process 300 for monitoring metrics information associated with a selected multimedia flow in accordance with aspects of the techniques described herein. The process 300 begins at 310 where the management unit 200 queries the probes 115 for metric information regarding the multimedia flow of interest. The process 300 may invoke SNMP service 230 (FIG. 2) to send SNMP query messages to the probes 115. At 320 the management unit 200 receives metric information from the probes 115 in response to the queries. The metric information may be correlated and summarized in steps 330 and 340, respectively. Optionally, the correlated and summarized metric information may be presented to a local user of the management unit 200 through an I/O device interface 255 for display at 350. In other embodiments, an SNMP trap mechanism may be used rather than SNMP query/response.

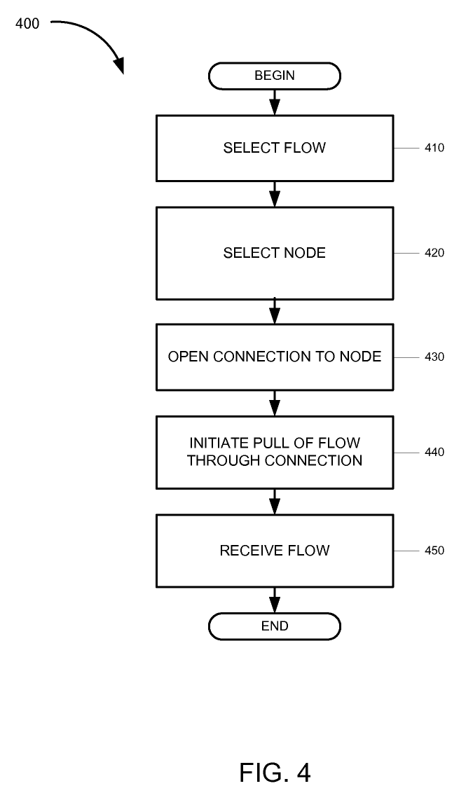

FIG. 4 illustrates a process 400 for selecting and receiving a copy of a multimedia flow in accordance with aspects of the techniques described herein. The process 400 begins at 410 where the management unit 200 or a local user of the management unit 200 selects a multimedia flow of interest, followed by selection of a node within that selected flow at 420. At 430 the management unit 200 opens a connection to the selected node. The connection may be a secure tunnel (e.g., GRE) or unsecure. Upon establishment of the connection with the selected node, the management unit 200 initiates a pull of a copy of the selected flow through the connection at 440. At 450 the management unit 200 receives the copy of the flow for further processing.

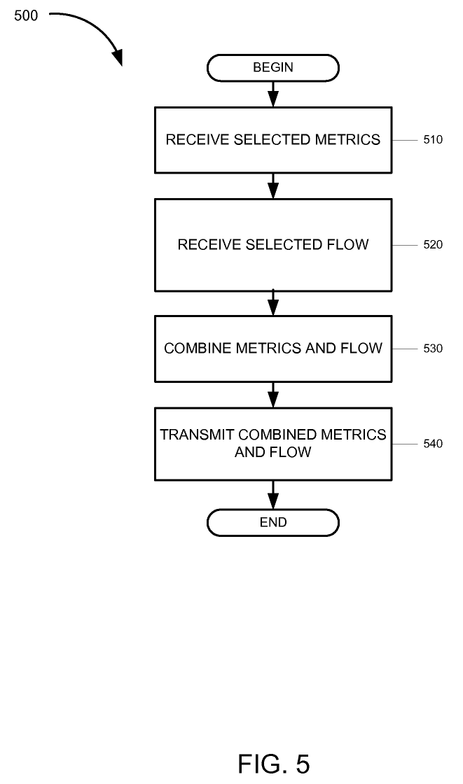

FIG. 5 illustrates a process 500 for combining metrics information with a selected multimedia flow in accordance with aspects of the techniques described herein. The process 500 begins at 510 with receipt of selected metrics from among the metric information received from the probes by metrics process 300 (FIG. 3). At 520 a copy of the selected flow is received in accordance with multimedia flow process 400 (FIG. 4). The two streams of data are combined at 530. The combined streams are transmitted at 540 to the encoder 130 (FIG. 1) for further processing and display to a NOC operator.

While this invention has been particularly shown and described with references to example embodiments thereof, it will be understood by those skilled in the art that various changes in form and details may be made therein without departing from the scope of the invention encompassed by the appended claims.

What is claimed is:

1. A method comprising:
receiving a copy of a multimedia flow from a point along the path of the multimedia flow through a communication network of nodes;
receiving metric information associated with the multimedia flow from one or more probes coupled to the flow path; and
combining the copy of the multimedia flow and at least a portion of the metric information to provide a combined signal.

2. The method of claim 1 further comprising sending the combined signal to one or more endpoints.

3. The method of claim 1 wherein combining comprises encoding the metric information as a closed caption signal and inserting the closed caption signal with the multimedia flow.

4. The method of claim 1 wherein combining comprises encoding the metric information as a text-to-audio stream and inserting the text-to-audio stream as an audio program with the multimedia flow.

5. The method of claim 1 wherein combining comprises encoding the metric information as a scrolling message signal and inserting the scrolling message signal with the multimedia flow.

6. The method of claim 5 wherein the scrolling message signal is inserted as an element in an elementary program stream of the multimedia flow.

7. The method of claim 5 wherein the scrolling message signal is inserted as an overlay graphic to a program stream of the multimedia flow.

8. The method of claim 1 wherein combining comprises encoding the metric information as a picture-in-picture signal and inserting the picture-in-picture signal with the multimedia flow.

9. The method of claim 1 wherein the metric information comprises any of diagnostic information, network configuration information, video measurement information and data measurement information.

10. The method of claim 1 wherein receiving a copy of the multimedia flow comprises opening a connection to a node along the path of the multimedia flow and pulling the copy of the multimedia flow into the connection.

11. The method of claim 1 wherein receiving metric information associated with the multimedia flow comprises querying the one or more probes using simple network management protocol and receiving the metric information from the one or more probes in response to querying.

12. The method of claim 1 wherein receiving metric information associated with the multimedia flow comprises using simple network management protocol trap messages to receive the metric information from the one or more probes.

13. An entity in a communication network of nodes, the entity comprising:
a network interface configured to receive a copy of a multimedia flow from a point along the path of a multimedia flow through the network of nodes and to receive metric information associated with the multimedia flow from one or more probes coupled to the flow path; and
processing circuitry configured to combine the copy of the multimedia flow and at least a portion of the metric information to provide a combined signal.

14. The entity of claim 13 wherein the processing circuitry is further configured to send the combined signal to one or more endpoints.

15. The entity of claim 13 further comprising an encoder for encoding the metric information as a closed caption signal and inserting the closed caption signal with the multimedia flow.

16. The entity of claim 13 further comprising an encoder for encoding the metric information as a text-to-audio stream and inserting the text-to-audio stream as an audio program with the multimedia flow.

17. The entity of claim 13 further comprising an encoder for encoding the metric information as a scrolling message signal and inserting the scrolling message signal with the multimedia flow.

18. The entity of claim 17 wherein the scrolling message signal is inserted as an element in an elementary program stream of the multimedia flow.

19. The entity of claim 17 wherein the scrolling message signal is inserted as an overlay graphic to a program stream of the multimedia flow.

20. The entity of claim 13 further comprising an encoder for encoding the metric information as a picture-in-picture signal and inserting the picture-in-picture signal with the multimedia flow.

21. The entity of claim 13 wherein the metric information comprises any of diagnostic information, network configuration information, video measurement information and data measurement information.

22. The entity of claim 13 wherein the processing circuitry is further configured to open a connection to a node along the path of the multimedia flow and pull the copy of the multimedia flow into the connection.

23. The entity of claim 13 wherein the processing circuitry is further configured to query the one or more probes using simple network management protocol and receive the metric information from the one or more probes in response to querying.

24. The entity of claim 13 wherein the processing circuitry is further configured to use simple network management protocol trap messages to receive the metric information from the one or more probes.
